(19) United States
(12) Patent Application Publication
(10) Pub. No.: US 2015/0102195 A1
(43) Pub. Date: Apr. 16, 2015

(54) Adjustable Nail Polish Bottle Holder

(71) Applicant: Connie Mah, Portland, OR (US)

(72) Inventor: Connie Mah, Portland, OR (US)

(21) Appl. No.: 14/051,257

(22) Filed: Oct. 10, 2013

(51) Int. Cl. F16M 11/20; F16M 11/04; A45D 34/04

(52) U.S. Cl. CPC F16M 11/2021; A45D 34/045; F16M 11/046
USPC 248/346.05; 248/346.06

(57) ABSTRACT

A liquid applicator bottle holder that retains any size of a fingernail polish bottle. The holder has a spring loaded top capture ring that is slidably mounted within a tilting, lockable arm that allows the fingernail polish bottle to be stored or used in an angled configuration, The upper surface of the base has grippable, sawtooth non slip surface that is contoured with a central depression so as to grip a portion of the base peripheral edge of the bottle. The device holds a fingernail polish bottle on an angle so that it is easier for the user to get the top applicator in and out of the bottle. It also allows the viscous, expensive fingernail polish to collect at a corner of the bottle so that it can more easily be picked up by the applicator, and is less likely to dry out, therein saving material costs. The holder has a tapered side stand configuration such that other liquid applicator bottle holder may be abutted adjacently so as to form a ring of holders or a nail polish station.

### BACKGROUND OF THE INVENTION

The present invention relates to a extremely compact holder for a small bottle of liquid material such as a fingernail polish. It is adapted to provide both conveniences for the user and to minimize the waste of the liquid material being applied.

Pedicures and manicures are commonplace in today's society, whether done professionally or personally. While, if for personal use, a bottle of fingernail polish may last years, in a nail salon such a bottle of this expensive fluid may last days. Each of these bottles comes with its own applicator affixed to the bottle's lid and extending downward into the bottle. The applicator has a length that leaves the bristles of its brush just short of the bottom of the bottle. As such, there is always a residual amount of nail polish left in the bottle when the applicator comes up dry. Tilting the bottle to get this residual amount to collect in one end of the bottle is a slow process because of the high viscosity of this fluid. If the residual fluid is left in the bottle in its normal position, it is prone to hardening on its exposed surface. Hence, the larger the exposed surface, the more of the polish that is likely to be wasted.

Additionally, the applicator is easier to withdraw and swipe its bristles against the bottle neck to regulate the amount of nail polish if the bottle is tilted.

Henceforth, an adjustable, tiltable nail polish bottle would fulfill a long felt need in the personal grooming industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a holder for nail polish bottles that is adjustable to accommodate a plethora of various sizes of bottles through a spring loaded height adjustable retention ring that fits over the applicator and neck of the bottle. It has many of the advantages mentioned heretofore and many novel features that result in a new nail polish bottle holder which is not anticipated, rendered obvious, suggested, or even implied by any of the prior art, either alone or in any combination thereof.

In accordance with the invention, an object of the present invention is to provide an improved nail polish bottle holder capable of maintaining the nail polish bottle at an adjustable, wide range of different angles.

It is another object of this invention to provide an improved nail polish bottle holder adapted to be mounted adjacent two other substantially similar nail polish bottle holders so as to form a circle of holders or a nail polish station.

It is a further object of this invention to provide an improved nail polish bottle holder that can quickly accommodate a bottle and quickly adjust the angle that the bottle is disposed at.

It is still a further object of this invention to provide for an improved nail polish bottle holder that can safely and securely hold the bottom of the angled bottle from movement.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front perspective view of the adjustable nail polish bottle holder;

FIG. 2 is an partially disassembled front perspective view of the adjustable nail polish bottle holder showing the general arrangement of all components;

FIG. 3 is a side view of the adjustable nail polish bottle holder illustrating in the phantom, the tiltable feature; and

FIG. 4 is a perspective view of the sawtoothed, contoured base mat of the adjustable nail polish holder;

FIG. 5 is a side rear view of the adjustable nail polish holder;

FIG. 6 is a side front view of the adjustable nail polish bottle holder;

FIG. 7 is a top view of the adjustable nail polish holder with the base mat and the neck collar removed'

FIG. 8 is a top view of the adjustable nail polish bottle holder with the base mat and neck collar installed;

FIG. 9 is a top view of a series of adjacent adjustable nail polish bottle holders arranged in adjacent abutment so as to form a circular station; and

FIG. 10 is a top view of a series of adjacent adjustable nail polish bottle holders arranged in adjacent abutment so as to form a linear station.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

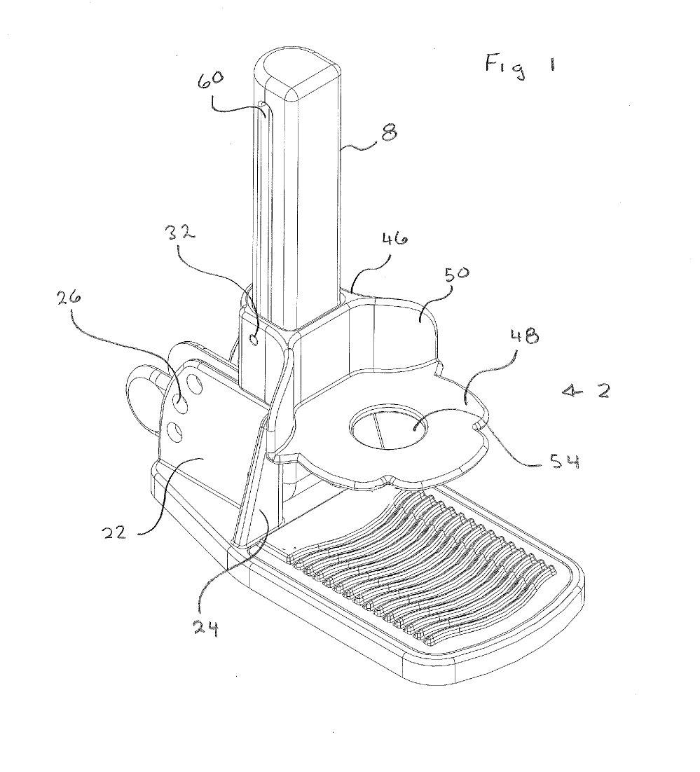

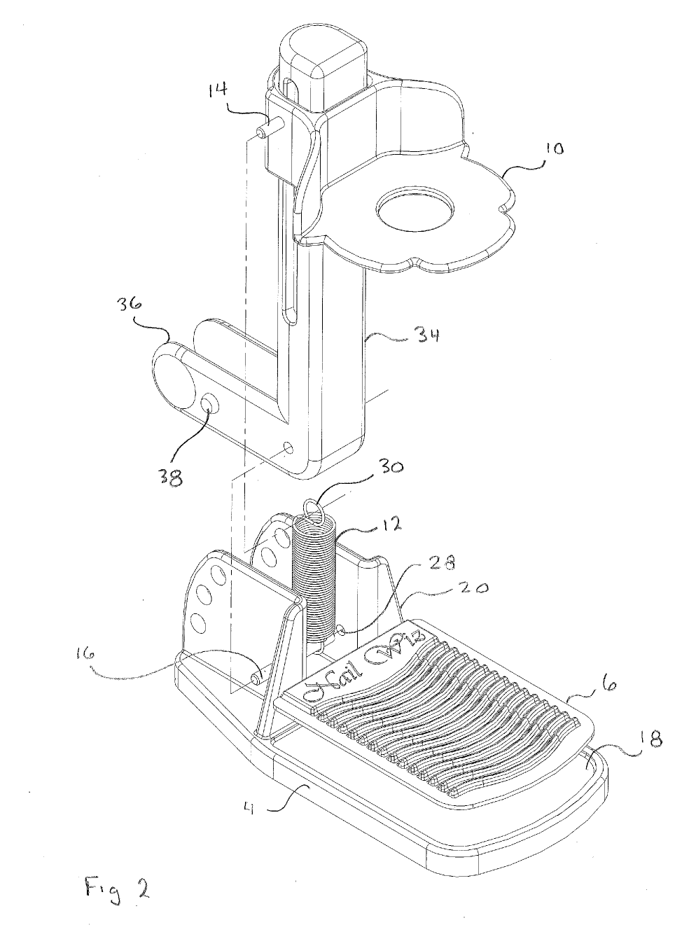

Looking at FIG. 1 the height and angle adjustable nail polish bottle holder 2 can be seen in its spring retracted configuration in the absence of a nail polish bottle. In FIG. 2 the holder 2 can be seen to be fashioned from the following seven parts. A base 4, a contoured, sawtoothed, grippable mat 6, a lockable angle, tiltable mast 8, a slidingly adjustable height neck collar 10, a coiled retraction spring 12, two spring retention pins (upper pin) 14 and (lower pin) 16.

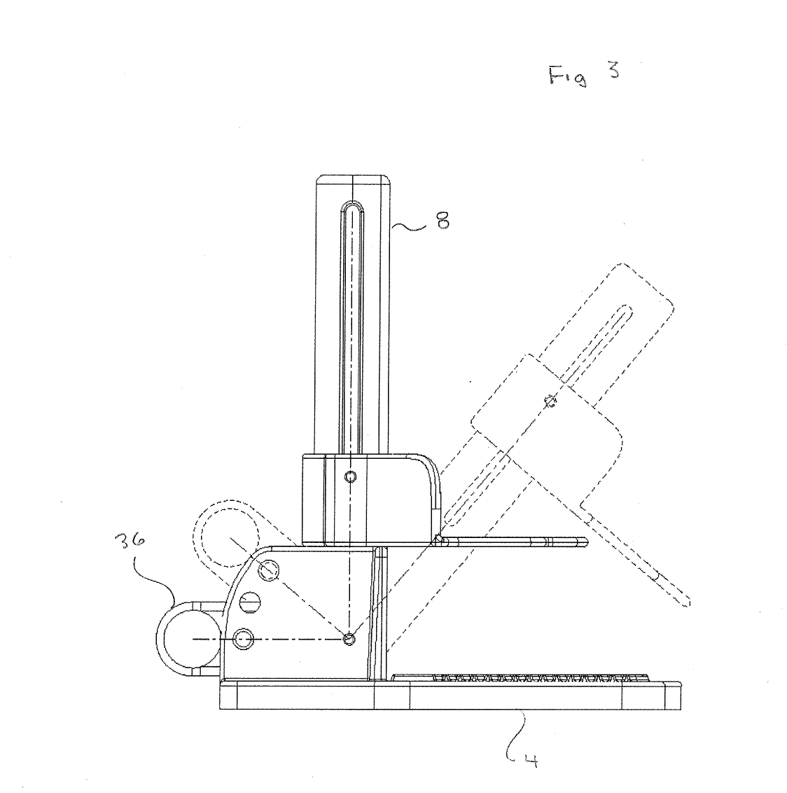

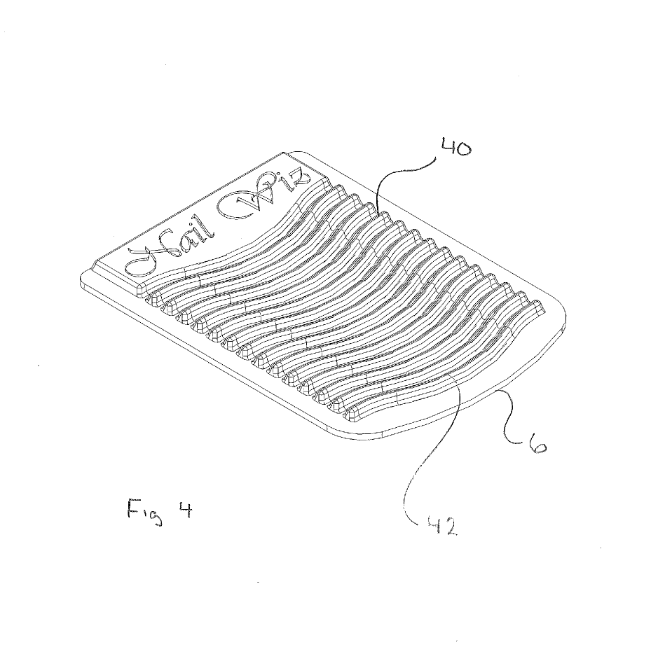

The base 4 has a planar bottom face, a mat receiving recess 18 and two mast receiving stanchions 20 that have a “Vee” shaped configuration thereto and extend normally from the horizontally disposed base 4 so as to reside vertically. The mat receiving recess 18 is matingly contoured to accept and retain the sawtoothed, grippable mat 6 illustrated in FIG. 4. The two mast receiving stanchions 20 each have a long side 22 and a short side 24 and are congruent, identical mirror image configurations that are arranged with their long sides equidistant about a plane extending normally from the longitudinal axis of the base 4. The long sides of the stanchions 22 have an arced series of opposing orifices 26 formed therethrough and a lower spring retention pin cutout 28. The mast 8 has an “Ell” configuration comprised of a hollow tube 34 with two flexible arms 36 extending normally therefrom. The hollow tube 34 has two vertical, parallel slots 60 milled through its sides. Each of the flexible arms has a protrusion 38 formed on their outer surface that matingly conforms to any in the arced series of opposing orifices 26 formed in the two mast receiving stanchions 20. As can be seen in FIG. 3 the flexible arms 36 can be squeezed towards each other so that their protrusions 38 are retracted from within the opposing orifices 26 and the mast 8 tilted so as to form an acute angle with respect to the base 4, wherein the flexible arms 36 can be released such that their protrusions 38 reside in a different set of opposing orifices 26. The majority of the spring 12 resides within the hollow tube 34 of the mast 8.

The neck collar 10 has a ring 46 that slidingly engages about the mast 8. This ring 46 has a pair of opposing upper spring retention pin cutouts 32 and a collar plate 48 that extends from the ring 48 so as to reside horizontally and approximately parallel to the plane of the base 4 when the mast 8 is in a vertical position. The collar plate has a bottle neck orifice 54 formed therethrough to accept the neck and applicator cap of the bottle. At the rear of the collar plate 48 there are two strengthening gussets 50 connected between the collar plate 48 and the ring 46 that serve to strengthen the connection of the parts on the neck collar 10.

The sawtoothed, grippable mat 6 illustrated in FIG. 4 in the preferred configuration if made of a pliable, gripple flat finish polymer that will reduce slippage of the bottle's bottom perimeter. There is a series of sawtooth teeth 40 extending upward from the mat 6 to further retard the bottle from slipping backward when residing in an angled configuration with the mast 8 tilted. The mat 6 has a slight central contour or depression 42 that retards the bottle from slipping sideways off the matt 6 when residing in an angled configuration with the mast 8 tilted.

Disposed vertically between the two mast receiving stanchions long sides 22 resides the coiled retraction spring 12. The spring 12 is terminated at both of its ends by loops 30 and is retained in the holder 2 by a lower spring retention pin 16 which passes through the loop 30 at the bottom of the spring 12 and is constrained in the two mast receiving stanchions long sides 22 in the lower spring retention pin 28 cutout, and by an upper spring retraction pin 14 which passes through the loop 30 at the top of the spring 12, then through the two vertical, parallel slots 60 in the hollow tube's sides, and is constrained in the upper spring retention pin cutout 32 in the neck collar 10. In this manner the spring 12 retracts in the vertical position so as to pull the neck collar 10 towards the base 4. Since the neck collar 10 is free to vertically slide outside the mast 8 the shoulders of various height bottles may be placed between the base 4 and the neck collar 10 such that the downward spring pressure will keep the bottle secured.

In operation, the neck collar 10 is pulled away from the base 4 against the retraction force of the spring 12 so as to widen the distance between the neck collar 10 and the base 4. A bottle of nail polish is placed on the mat 6 and the neck and applicator cap of the bottle are placed through the bottle neck orifice 54 of the collar plate 48. The neck collar 10 is returned by its spring 12 such that the bottle is firmly constrained between the base 4 and the neck collar 10. The flexible arms 36 of the mast 8 are squeezed towards each other and after tilting the mast 8 to the desired angle with respect to the base 4 the flexible arms 36 can be released such that their protrusions 38 reside in a different set of opposing orifices 26. When in a tilted configuration, a portion of the bottom periphery of the bottle is held from sliding backwards or sideways by the contour and toothed design of the mat 6.

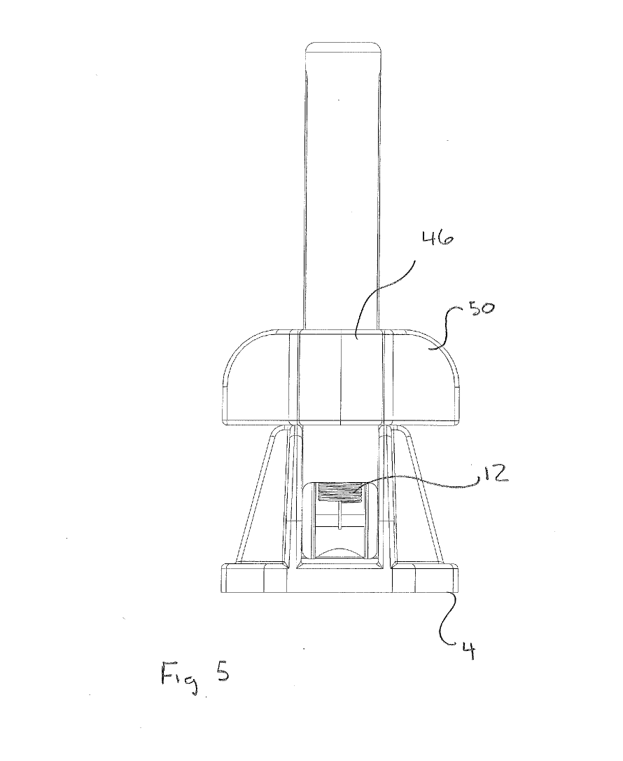

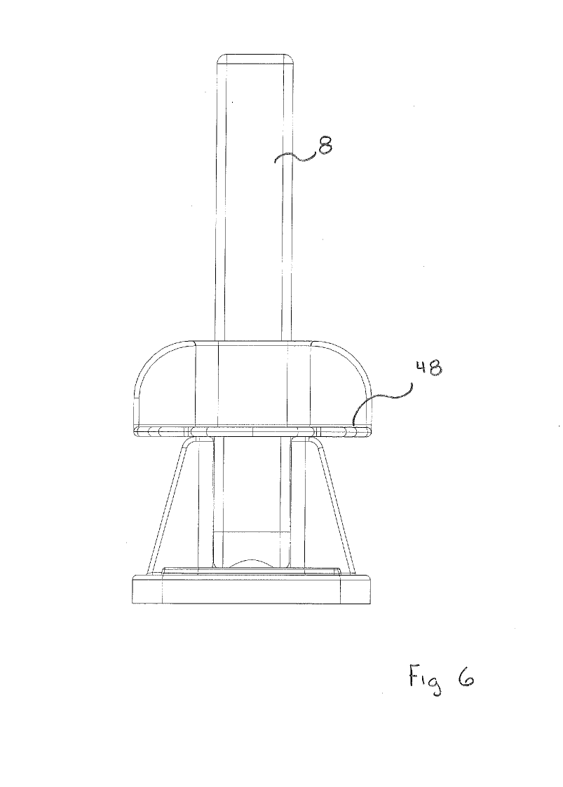

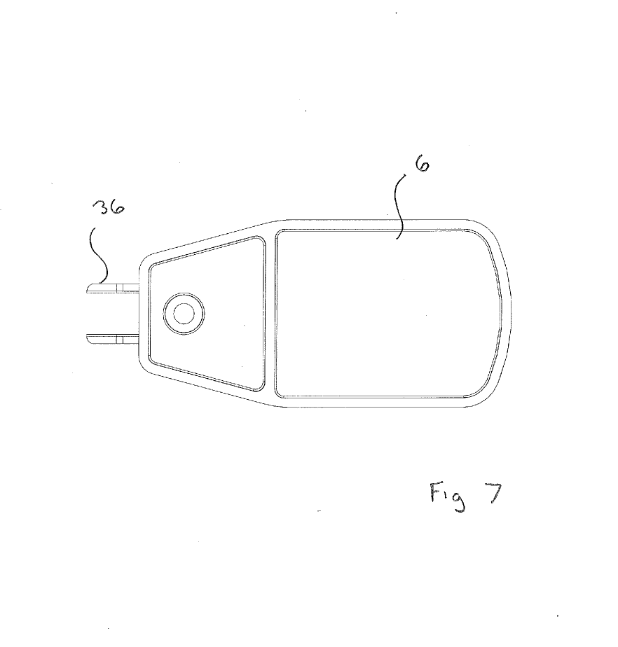

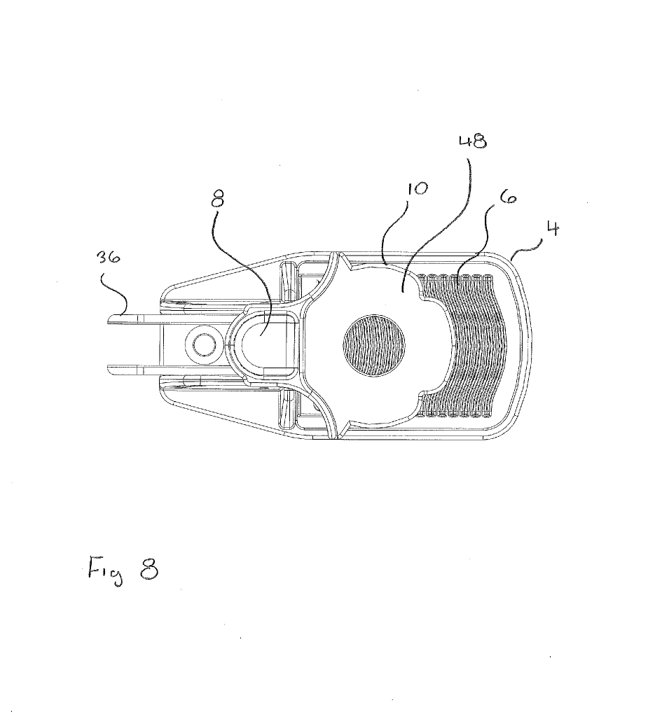

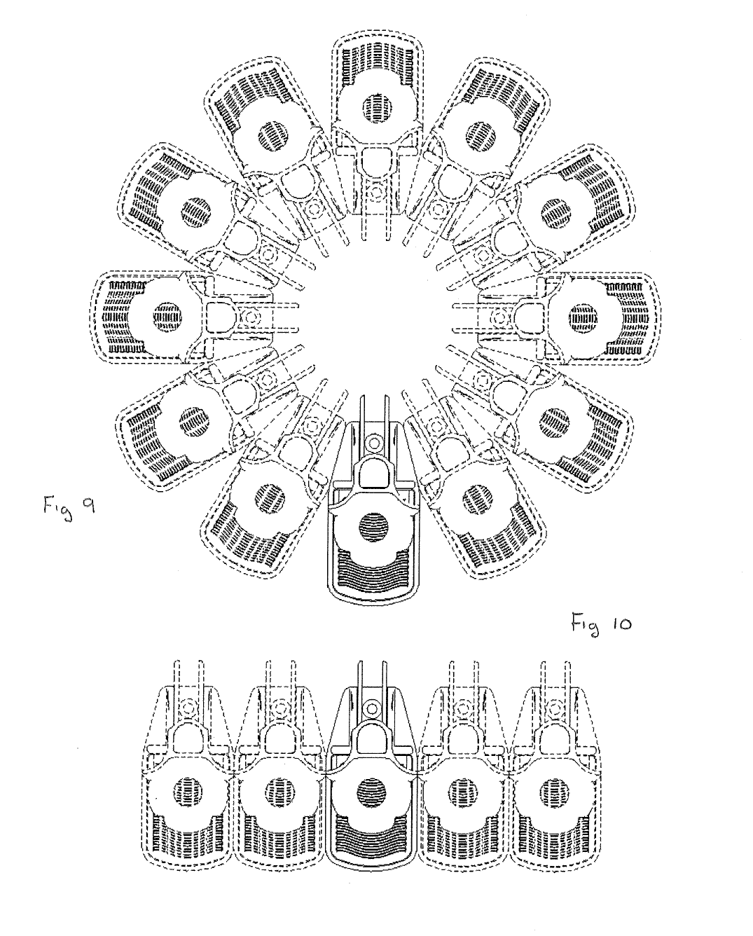

FIGS. 5-8 illustrate the holder 2 from various angles and with parts removed for mechanical visualization purposes. As shown in FIGS. 9 and 10 an array of the holders 2 may be arranged in different configurations for a circular (FIG. 9) or a linear (FIG. 10) station.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A size adjustable nail polish bottle holder comprising:
a generally planar base;
a mast pivotally affixed to said planar base;
a neck collar slidingly affixed about said mast; and
a spring affixed between said base and said neck collar so as to exert a retraction force to draw said neck collar in close proximity to said base.

2. The size adjustable nail polish bottle holder of claim 1 wherein said mast is tiltable, being able to pivot so as form an acute included angle between said mast and said base.

3. The size adjustable nail polish bottle holder of claim 2 wherein said mast when in a tilted configuration with respect to said base, may be locked in said tilted configuration.

4. The size adjustable nail polish bottle holder of claim 1 further comprising a centrally contoured, grippable mat, wherein said planar base has a recess on an upper surface thereof matingly conformed to accept said grippable mat.

5. The size adjustable nail polish bottle holder of claim 4 wherein said grippable mat has a sawtooth configuration on a top face thereof, that is adapted to constrain a bottom of said bottle from moving backward.

6. The size adjustable nail polish bottle holder of claim 1 wherein said neck collar has a centrally located orifice formed therethrough to accommodate a nail polish bottle.

7. The size adjustable nail polish bottle holder of claim 1 further comprising:
an upper spring retention pin; and
a lower spring retention pin; wherein said upper spring retention pin connects a top end of said spring to said neck collar and said lower spring retention pin connects a lower end of said spring to said base.

8. The size adjustable nail polish bottle holder of claim 7 wherein said mast has at least one vertical slot formed therein that slidingly receives said upper spring retention pin so as to allow said neck collar to slid about said mast.

9. The size adjustable nail polish bottle holder of claim 1 wherein said base has a planar bottom face and two mast receiving stanchions that extend normally and vertically from said base.

10. The size adjustable nail polish bottle holder of claim 9 wherein said mast receiving stanchions have an arced series of opposing orifices formed there through.

11. The size adjustable nail polish bottle holder of claim 10 wherein said mast is comprised of a hollow tube having two flexible arms extending normally therefrom, said flexible arms having a protrusion formed on an outer surface thereof that matingly conforms to any in the arced series of opposing orifices formed in the said mast receiving stanchions.

12. The size adjustable nail polish bottle holder of claim 1 wherein said neck collar has a ring that slidingly engages about said mast mast.

13. The size adjustable nail polish bottle holder of claim 12 wherein said neck collar is made of said ring connected to a collar plate with a bottle neck orifice formed therethrough that extends from said ring so as to reside horizontally and approximately parallel to said base when said mast is in a vertical position.

14. The size adjustable nail polish bottle holder of claim 13 wherein there are two strengthening gussets connected between said collar plate and said ring.

15. The size adjustable nail polish bottle holder of claim 14 wherein said mast receiving stanchions has a pair of lower spring retention pin orifices for receiving said lower spring retention pins, and wherein said ring has a pair of upper spring retention pin orifices for receiving said upper spring retention pins.

16. The size adjustable nail polish bottle holder of claim 1 wherein said planar base has a peripheral edge that forms a front, a rear and two sides and wherein said two sides are mirror images of each other taken about a longitudinal centerline of said base.

17. The size adjustable nail polish bottle holder of claim 16 wherein said sides are not linear in configuration but rather have a first portion and a second portion having an obtuse angle formed there between, such that when said second portions of said sides of adjacent nail polish bottle holders are in contact with each other, the nail polish holders will form a ring.

18. The size adjustable nail polish bottle holder of claim 16 wherein said sides are not linear in configuration but rather have a first portion and a second portion having an obtuse angle formed there between, such that when said first portions of said sides of adjacent nail polish bottle holders are in contact with each other, the nail polish holders will form a line.

19. A size adjustable and tiltable bottle holder comprising:
a generally planar horizontal base having a pair of stanchions extending vertically therefrom, said stanchions having a lower spring retention pin orifice formed therethrough;
a tilting mast pivotally affixed to said stanchions of said planar base, said mast having two arms extending therefrom and a pair of parallel slots formed therethrough said mast;
a neck collar formed of a ring with a collar plate extending therefrom an exterior surface thereof, said ring matingly conformed for slidingly engagement about said mast;
a lower spring retention pin;
an upper spring retention pin; and
a coiled retraction spring partially housed within said mast, said spring having an upper connection loop and a lower connection loop formed at the ends thereof;
wherein said upper connection loop is affixed to said neck collar by said upper spring retention pin which resides in said upper spring retention pin orifices and passes through said pair of parallel slots in said mast, and said lower connection loop is affixed to said base by said lower spring retention pin which resides in said lower spring retention pin orifices.

20. A size adjustable and tiltable bottle holder of claim 19 further comprising a centrally contoured, sawtooth surfaced mat affixed to said planar base.
